(19) United States
(12) Patent Application Publication
(10) Pub. No.: US 2013/0320590 A1
(43) Pub. Date: Dec. 5, 2013

(54) METHOD FOR TREATING THERMOPLASTIC JOUNCE BUMPERS

(71) Applicant: E I Du Pont De Nemours and Company, Wilmington, DE (US)

(72) Inventor: PETER LASZLO SZEKELY, Pringy (FR)

(73) Assignee: E I Du Pont De Nemours and Company, Wilmington, DE (US)

(21) Appl. No.: 13/890,612

(22) Filed: May 9, 2013

Related U.S. Application Data
(60) Provisional application No. 61/654,135, filed on Jun. 1, 2012.

(51) Int. Cl. B29C 67/00

(52) U.S. Cl. CPC B29C 67/00
USPC 264/294

(57) ABSTRACT

The invention provides a process for improving the elastic recovery of a jounce bumper made from a copolyetherester, while not affecting its height when fully compressed.

### CROSS REFERENCE TO RELATED APPLICATIONS

This application claims the benefit of U.S. Provisional Application No. 61/654,135, filed Jun. 1, 2012, now pending, the entire disclosure of which is incorporated herein by reference.

### FIELD OF INVENTION

The present invention relates to the field of vehicle suspension systems, and more particularly to jounce bumpers.

### BACKGROUND OF THE INVENTION

A jounce bumper (also called a bump stop, rebound bumper, end-of-travel bumper, strike-out bumper, suspension bumper, or compression bumper) is a shock-absorbing device ordinarily positioned on the top of vehicle suspensions. Jounce bumpers for use in motor vehicle suspension systems have long been used for cushioning the impact between two suspension system components, such as the shock absorber and a portion of the frame, as well as for attenuating noise and vibration to increase the ride comfort of the passengers. Since displacement of the vehicle chassis causes displacements of the shock absorber, the shock absorber undergoes cycles of compression and extension in response to the displacement of the vehicle chassis. Provision must be made for protecting the shock absorber assembly and the vehicle body from the jounce forces associated with severe irregularities in the road surface leading to extreme displacement of the suspension. For this reason, a jounce bumper is attached to the suspension system at a point where impact is likely to occur when the shock absorber fails to absorb the forces created by extraordinary driving conditions. Particularly, during jounce motions of the shock absorber, the damper “bottoms out” and the jounce bumper moves into contact with the shock absorber plate and compresses to dissipate energy resulting in cushioning the impact, reducing noise, reducing the sensation of impact to the passengers and reducing possible damage to the vehicle suspension system. Jounce bumpers are elongated, generally cylindrical or conical, members with or without convolutes, made of a compressible and elastomeric material that extends generally around the piston rod. As taught in U.S. Pat. No. 4,681,304, convoluted bumpers function by a progressive stacking of the convolutions to provide resistance to jounce forces.

Materials suitable for this application must be resilient, i.e. capable of withstanding shock without undue permanent deformation or rupture, and must have excellent flex life. Conventional jounce bumpers are formed of foamed polyurethane and vulcanized rubber. For example, jounce bumpers are often formed of microcellular polyurethane (MCU). A microcellular polyurethane jounce bumper is made by casting polyurethane precursors in a jounce bumper mold. Microcellular foam is obtained from the reaction of diisocyanate glycol with a blowing agent or with water which produces carbon dioxide gas for foaming. This technology is time-consuming since foaming requires prolonged times in the mold due to the slow release of carbon dioxide. Foamed polyetherester compositions are also known. A process for improving compression set resistance of such foamed compositions is disclosed in U.S. Patent Publication 2012/0098158A1.

While jounce bumpers made of foamed polyurethane have good ride characteristics, they are expensive to produce since they require an energy- and time-consuming technology due to the crosslinking step.

With the aim of improving durability, inertness to automotive fluids, and resistance to tear propagation of the material used to form the jounce bumper, U.S. Pat. No. 5,192,057 discloses an elongated hollow body formed of a non-foamed elastomer, preferably from a copolyetherester polymer. As disclosed therein, such pieces, including jounce bumpers having bellows shaped sections with a constant thickness profile, are manufactured by blow molding techniques. An alternative method for forming jounce bumpers, i.e. corrugated extrusion, is described in U.S. Published Patent Application No. 2008/0272529.

In general, it is desired to maximize the elastic recovery of a jounce bumper made from a copolyetherester polymer, and methods to do this are desirable.

### SUMMARY OF THE INVENTION

In a first aspect, the invention provides a process for enhancing the elastic recovery of a jounce bumper made from copolyester thermoplastic elastomer having polyester hard segments and polyoxyalkylene soft segments, the process comprising:
A) providing a jounce bumper made from copolyester thermoplastic elastomer;
B) annealing the jounce bumper at an annealing temperature that is at least at or about the T_{g} of the polyester making up the hard segments of the copolyester thermoplastic elastomer for a period of 20 to 60 minutes to form an annealed jounce bumper having an uncompressed thickness;
C) pre-loading the annealed jounce bumper, at a pre-loading temperature that is at least room temperature, by compressing the jounce bumper to reduce its height by 20 to 90% of its uncompressed height;
D) releasing the compression;
E) repeating steps C) and D) at least once; and
F) allowing the jounce bumper to cool to less than 30° C.

In a second aspect, the invention provides a process for enhancing the elastic recovery of a jounce bumper made from copolyester thermoplastic elastomer having polyester hard segments and polyoxyalkylene soft segments, the process comprising:
A) providing a jounce bumper made from copolyester thermoplastic elastomer;
B) annealing the jounce bumper at an annealing temperature that is at least at or about the T_{g} of the polyester making up the hard segments of the copolyester thermoplastic elastomer for a period of 20 to 60 minutes to form an annealed jounce bumper having an uncompressed thickness;
C) compressing, at a pre-loading temperature that is at least at or about the T_{g} of the polyester making up the hard segments of the copolyester thermoplastic elastomer, the annealed jounce bumper to reduce its height by 20 to 90% of its uncompressed height;
D) releasing the compression;
E) repeating steps C) and D) at least once; and
F) allowing the jounce bumper to cool to less than 30° C.

### BRIEF DESCRIPTION OF THE DRAWINGS

FIG. 1 is a schematic broken view of an “inward” jounce bumper, wherein Re designates the external radius at a peak, Ri designates the external radius at a trough, and P represents the distance from peak to peak (the pitch).

FIG. 2 is a schematic cross-section enlarged view of FIG. 1, wherein the dashed line represents the longitudinal axis of the jounce bumper, rs designates the fillet radius of an outward convolute, and rc designates the fillet radius on an inward convolute.

FIG. 3 is a schematic broken view of an “outward” jounce bumper, wherein Re designates the external radius at a peak, Ri designates the external radius at a trough, and P represents the distance from peak to peak (the pitch).

FIG. 4 is a schematic cross-section enlarged view of FIG. 3, wherein the dashed line represents the longitudinal axis of the jounce bumper, rs designates the fillet radius of an outward convolute, and rc designates the fillet radius on an inward convolute.

### DETAILED DESCRIPTION OF THE INVENTION

All documents referred to herein are incorporated by reference.

The inventors have found that for jounce bumpers made of copolyester thermoplastic elastomer containing polyester hard segments and polyoxyalkylene soft segments, the elastic recovery is improved if the jounce bumper is subjected to an annealing treatment at a temperature that is at least at or about the glass transition temperature (T_{g}) of the polyester making up the hard segments, for a period of at least 20 minutes. Following annealing, the jounce bumper is subjected to a pre-loading treatment, which consists of at least one cycle of compression and relaxation. The pre-loading may be carried out at least room temperature, or it may be carried out at a higher temperature, preferably it is carried out at a temperature that is at least at or about the T_{g} of the of the polyester making up the hard segments of the copolyester thermoplastic elastomer.

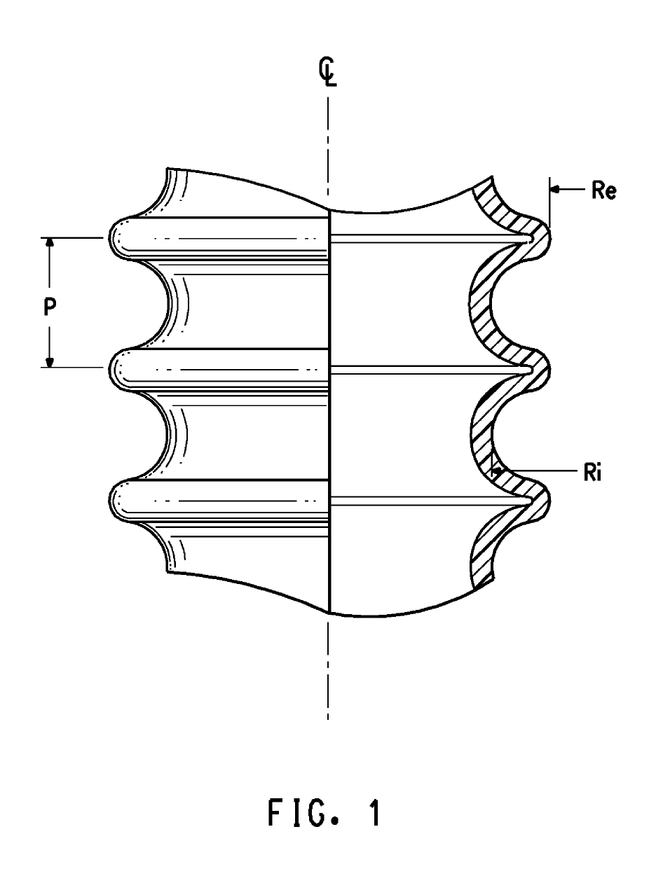

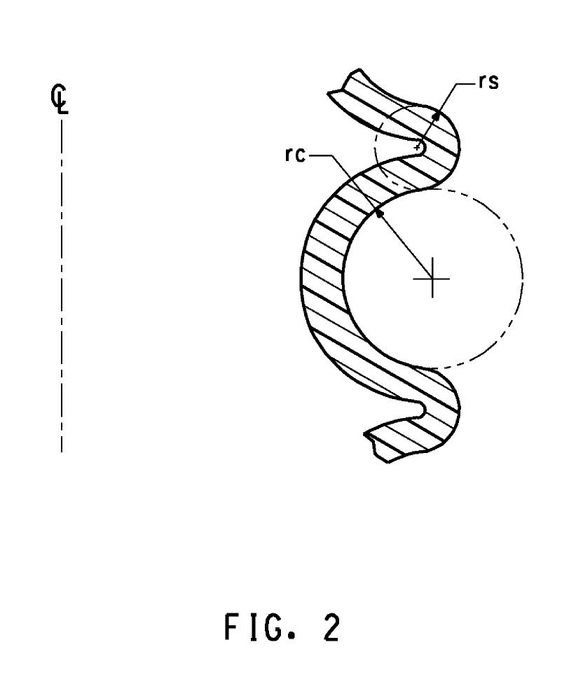

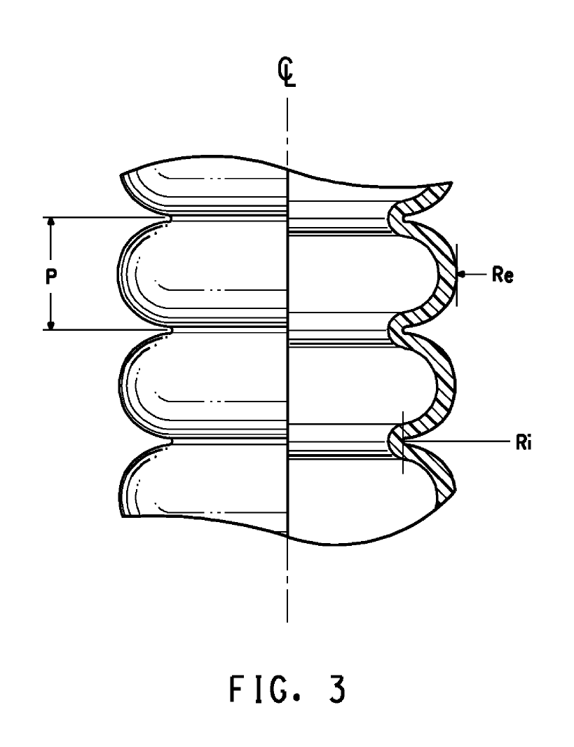

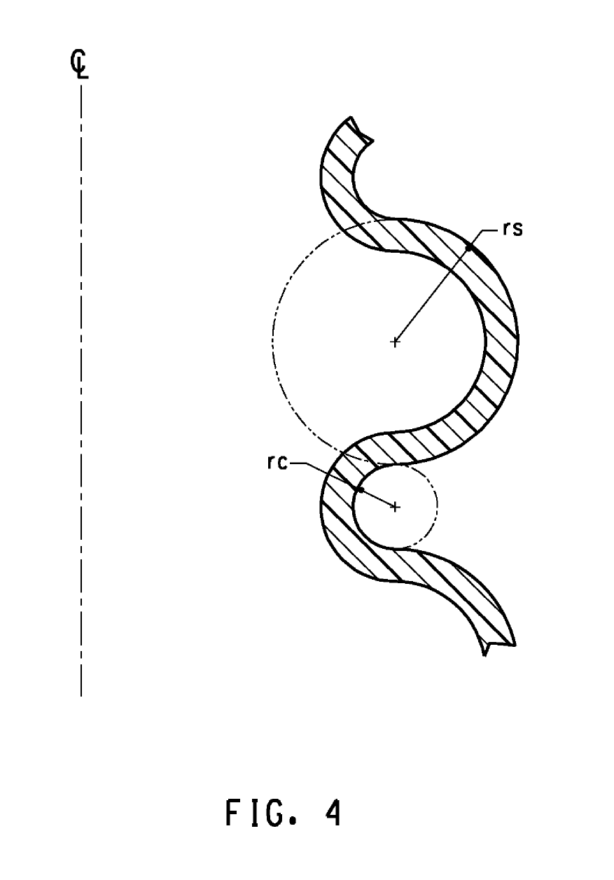

A jounce bumper is a hollow tubular shock absorbing member that works in axial compression, made from copolyester thermoplastic elastomer. A jounce bumper made from copolyester thermoplastic elastomer has a hollow tubular profile, as illustrated in FIGS. 1 and 3. The tube of the jounce bumper has convolutes or bellows, making the jounce bumper susceptible to compression along its longitudinal axis. The bellows have peaks (the point on the curve furthest from the longitudinal axis of the jounce bumper) and troughs (the point on the curve closest to the longitudinal axis of the jounce bumper). The process of the invention relates to both “inward” and “outward” jounce bumpers. An example of an inward jounce bumper is illustrated in FIG. 1, and enlarged in FIG. 2. In FIG. 2, rs designates the fillet radius of an outward convolute, and rc designates the fillet radius on an inward convolute. Inward jounce bumpers are those in which rc>rs. An example of an outward jounce bumper is illustrated in FIG. 3, and enlarged in FIG. 4. In FIG. 4, rs designates the fillet radius of an outward convolute, and rc designates the fillet radius on an inward convolute. Outward jounce bumpers are all those in which rc<rs.

The process of the invention works with copolyester thermoplastic elastomer jounce bumpers fabricated by any method. Known methods for fabricating copolyester thermoplastic elastomer jounce bumpers include, for example: extrusion blow-moulding, corrugated extrusion and injection moulding.

Preferred copolyester thermoplastic elastomers are typically derived from one or more dicarboxylic acids (where herein the term “dicarboxylic acid” also refers to dicarboxylic acid derivatives such as esters) and one or more diols. In preferred polyesters the dicarboxylic acids comprise one or more of terephthalic acid, isophthalic acid, and 2,6-naphthalene dicarboxylic acid, and the diol component comprises one or more of HO(CH₂)ₙOH (I); 1,4-cyclohexanedimethanol; HO(CH₂CH₂O)ₘCH₂CH₂OH (II); and HO(CH₂CH₂CH₂CH₂O)_{z}CH₂CH₂CH₂CH₂OH (III), wherein n is an integer of 2 to 10, m on average is 1 to 4, and z is on average about 7 to about 40. Note that (II) and (III) may be a mixture of compounds in which m and z, respectively, may vary and that since m and z are averages, they need not be integers. Other dicarboxylic acids that may be used to form the thermoplastic polyester include sebacic and adipic acids. Hydroxycarboxylic acids such as hydroxybenzoic acid may be used as comonomers. Specific preferred polyesters include poly(ethylene terephthalate) (PET), poly(trimethylene terephthalate) (PTT), poly(1,4-butylene terephthalate) (PBT), poly(ethylene 2,6-naphthoate), and poly(1,4-cyclohexyldimethylene terephthalate) (PCT).

Copolyester thermoplastic elastomers (TPC) such as copolyetheresters or copolyesteresters are copolymers that have a multiplicity of recurring long-chain ester units and short-chain ester units joined head-to-tail through ester linkages, said long-chain ester units being represented by formula (A):

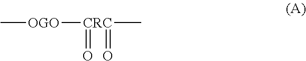

and said short-chain ester units being represented by formula (B):

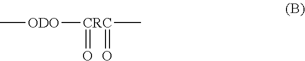

wherein
G is a divalent radical remaining after the removal of terminal hydroxyl groups from poly(alkylene oxide)glycols having preferably a number average molecular weight of between about 400 and about 6000; R is a divalent radical remaining after removal of carboxyl groups from a dicarboxylic acid having a molecular weight of less than about 300; and D is a divalent radical remaining after removal of hydroxyl groups from a diol having a molecular weight preferably less than about 250; and wherein said copolyetherester(s) preferably contain from about 15 to about 99 wt. % short-chain ester units and about 1 to about 85 wt. % long-chain ester units.

As used herein, the term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxy groups and having a number average molecular weight of from about 400 to about 6000, and preferably from about 600 to about 3000. Preferred poly(alkylene oxide) glycols include poly(tetramethylene oxide) glycol, poly(trimethylene oxide) glycol, poly(propylene oxide) glycol, poly(ethylene oxide) glycol, copolymer glycols of these alkylene oxides, and block copolymers such as ethylene oxide-capped poly(propylene oxide) glycol. Mixtures of two or more of these glycols can be used.

The term “short-chain ester units” as applied to units in a polymer chain of the copolyetheresters refers to low molecular weight compounds or polymer chain units. They are made by reacting a low molecular weight diol or a mixture of diols with a dicarboxylic acid to form ester units represented by Formula (B) above. Included among the low molecular weight diols which react to form short-chain ester units suitable for use for preparing copolyetheresters are acyclic, alicyclic and aromatic dihydroxy compounds. Preferred compounds are diols with about 2-15 carbon atoms such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, and the like. Especially preferred diols are aliphatic diols containing 2-8 carbon atoms, and a more preferred diol is 1,4-butanediol.

Copolyetheresters that have been advantageously used for the manufacture of the jounce bumper of the present invention are commercially available from E. I. du Pont de Nemours and Company, Wilmington, Del. under the trademark Hytrel® copolyetherester elastomer.

According to a preferred embodiment, jounce bumpers according to the present invention are made of copolyester thermoplastic elastomers (TPC) such as copolyetheresters or copolyesteresters, and mixtures thereof. More preferably a copolyetherester is used that is made from an ester of terephthalic acid, e.g. dimethylterephthalate, 1-4 butanediol and a poly(tetramethylene ether) glycol. The weight percent of short-chain ester units is about 50 where the remainder is long-chain ester units. In a preferred embodiment the jounce bumper is made of a copolyetherester having hard segments consisting of polybutylene terephthalate, and soft segments consisting of polytetramethylene oxide. The copolyetherester preferably has approximately 48 mol % polyether soft segments.

The process of the invention involves an annealing step and a pre-loading step. During the annealing step, the jounce bumper is heated to an annealing temperature that is at least at or about the T_{g} of the polyester making up the hard segments of the copolyester thermoplastic elastomer. T_{g}'s for various polyesters are listed below:

### Poly(butyleneterephthalate) (“PBT”): 40 to 55° C.

### Poly(trimethyleneterephthalate) (“PTT”): 50 to 65° C.

### Poly(ethyleneterephthalate) (“PET”): 70 to 80° C.

For a jounce bumper made from a copolyester thermoplastic elastomer that has PBT hard segments, annealing should be carried out at an annealing temperature of at least about 50° C., preferably at 70-120° C. For a jounce bumper made from a copolyester thermoplastic elastomer that has PTT hard segments, annealing should be carried out at an annealing temperature of at least about 60° C., preferably at 70-120° C. For a jounce bumper made from a copolyester thermoplastic elastomer that has PET hard segments, annealing should be carried out at an annealing temperature of at least 90° C., preferably at 120-150° C.

The annealing temperature should not be so high that the copolyester thermoplastic elastomer begins to melt. Preferably it is not higher than 50 degrees below the melting temperature of the polyester making up the hard segments of the copolyester thermoplastic elastomer. More preferably it is not higher than 70 degrees below the melting temperature of the polyester making up the hard segments of the copolyester thermoplastic elastomer, even more preferably it is not higher than 90 degrees below the melting temperature of the polyester making up the hard segments of the copolyester thermoplastic elastomer. The melting temperatures of some polyesters are listed below:

### Poly(butyleneterephthalate) (“PBT”): 220-230° C.

### Poly(trimethyleneterephthalate) (“PTT”): 222-235° C.

### Poly(ethyleneterephthalate) (“PET”): 250-260° C.

During the annealing step, the jounce bumper is heated to and held at the annealing temperature for at least 20 minutes (the annealing period). The inventors have found that an annealing period of approximately 1 hour gives a substantial improvement in elastic recovery. Annealing periods of longer than 60 minutes do not yield substantial improvement in elastic recovery. The annealing step may be carried out at a relatively constant temperature, or the temperature may vary during the annealing step, provided it does not go substantially below the T_{g} of the polyester making up the hard segments of the copolyester thermoplastic elastomer.

Annealing may be carried out using a jounce bumper that has been cooled to room temperature or below, in which case the jounce bumper must first be heated to the annealing temperature. Alternatively, if annealing is carried out immediately after fabrication of the jounce bumper, the jounce bumper will already be at an elevated temperature, so that annealing can be carried out, if desired for a shorter period of time, simply by holding the jounce bumper at an elevated temperature after fabrication.

The pre-loading step is carried out after annealing by subjecting the jounce bumper to a compression cycle along its longitudinal axis, at least once, preferably multiple times, such as two, three, four or five times. The compression preferably reduces the jounce bumper height by at least 20 to 90% of its uncompressed height at maximal compression (relative deformation), before releasing the jounce bumper completely, preferably the relative deformation is 60-75%, particularly preferably about 70%. Preferably the pre-loading treatment is at least 2 cycles from 0 to at least 60% of relative deformation of the jounce bumper. The relative deformation is the ratio of deformation to initial height of the jounce bumper. For example, if the uncompressed height is 100 mm, and the jounce bumper is compressed so that its height reduces by 20 mm, the relative deformation is 20%. A typical speed of compression is about 50 mm/minute. However the speed can be as low as 1 mm/minute or as high as 1 m/minute. A preferred method for pre-loading is to compress the jounce bumper longitudinally using a force of 0-12 kN (preferably 10 kN) preferably at a rate of 50 mm/minute, followed by release at the same rate. Preferably this compression is carried out three times.

Pre-loading may be carried out a room temperature, but better results are obtained (in terms of elastic recovery) if the pre-loading steps are carried out at a pre-loading temperature that is at least at or about the T_{g} of the polyester making up the hard segments of the copolyester thermoplastic elastomer. The pre-loading temperature should not be so high that the copolyester thermoplastic elastomer begins to melt. Preferably it is not higher than 50 degrees below the melting temperature of the polyester making up the hard segments of the copolyester thermoplastic elastomer. More preferably it is not higher than 70 degrees below the melting temperature of the polyester making up the hard segments of the copolyester thermoplastic elastomer, even more preferably it is not higher than 90 degrees below the melting temperature of the polyester making up the hard segments of the copolyester thermoplastic elastomer. The pre-loading step may be carried out at a relatively constant temperature, or the temperature may vary during the pre-loading step, provided it does not go substantially below the T_{g} of the polyester making up the hard segments of the copolyester thermoplastic elastomer.

For a jounce bumper made from a copolyester thermoplastic elastomer that has PBT hard segments, pre-loading should be carried out at a pre-loading temperature of at least 50° C., preferably at 70-120° C. For a jounce bumper made from a copolyester thermoplastic elastomer that has PTT hard segments, pre-loading should be carried out at a pre-loading temperature of at least 60° C., preferably at 70-120° C. For a jounce bumper made from a copolyester thermoplastic elastomer that has PET hard segments, pre-loading should be carried out at a pre-loading temperature of at least 90° C., preferable at 120-150° C.

For convenience, the pre-loading step can be carried out immediately after the annealing step, and the pre-loading temperature may be substantially the same as the annealing temperature. In one preferred embodiment, the annealing step is carried out immediately after fabrication of the jounce bumper, before the jounce bumper has substantially cooled, and pre-loading is carried our immediately after annealing, before the jounce bumper has substantially cooled.

### EXAMPLES

Jounce bumpers were made from a copolyetherester having hard segments consisting of polybutylene terephthalate, and soft segments consisting of polytetramethylene oxide. The copolyetherester had approximately 48 mol % polyether soft segments.

The jounce bumpers were made by extrusion blow-moulding. After blow-moulding, they were allowed to cool to room temperature (23° C.). Both inward and outward jounce bumpers were tested.

Jounce bumpers 1 (results shown in Table 1) were outward jounce bumpers having the following dimensions: number of bellows (N): 4; wall thickness profile: Maximum thickness at a trough (Tc)=2.8 mm; Maximum thickness at a peak (Ts)=1.7 mm; other dimensions: Re=18.5 mm; Ri=11.8 mm; Pitch (P)=15 mm.

Jounce bumpers 2 (results shown in Table 2) were inward jounce bumpers having the following dimensions: number of bellows (N): 2.5; wall thickness profile: Maximum thickness at a trough (Tc)=3.9 mm; Maximum thickness at a peak (Ts)=2.25 mm; other dimensions: Re=32.7 mm; Ri=20.7 mm; Pitch (P)=24

### Annealing Treatment

The controls (designated with a “C” in Table 1) were not given any annealing treatment before being subjected to pre-loading conditioning. The jounce bumpers subjected to the process of the invention (designated with an “EX” in Table 1) were subjected to annealing by heating in an oven at 70° C. or 120° C., for approximately one hour.

### Pre-Loading

Except where otherwise noted, pre-loading was done by subjecting the jounce bumper to 3 compression cycles of 0-10 kN at 50 mm/min. For the jounce bumpers 1, this resulted in a relative deformation at maximum compression of about 69%. For the jounce bumpers 2, this resulted in a relative deformation at maximum compression of 72%. The cycles were either done at room temperature, or at 70 or 120° C. After pre-loading, the jounce bumpers were allowed to “rest” for one hour, and the height of the jounce bumper was measured, giving the initial height or h₀.

### Fatigue Testing

Two kinds of fatigue treatment have been used for both the controls and the experimentally heat treated jounce bumpers. One of them consists of 177,000 cycles of from 0 to 3000N at 23° C. and 2 cycles per second (2 Hz). The second fatigue test consists of 150,000 cycles of from 0 to 7000N at 23° C. and 1.5 cycles per second (1.5 hz). After the fatigue treatment the height of the jounce bumpers was measured after twenty four hours (h₂₄). Relative variation of height (“A”) provides a measure of loss of height after the fatigue test, as measured 24 hours after the fatigue test, and is calculated as follows:

$$Δ = Relative variation of height = \frac{{h}_{0} - {h}_{2}}{{h}_{0}} \times 100 \%$$

Data for the controls and the jounce bumpers subjected to the inventive treatment are summarized in Tables 1 and 2. Controls are designated with a “C”, and jounce bumpers treated according to the invention are designated “EX”.

All jounce bumpers including the controls show a decrease in measured height after the fatigue treatment. The smaller the value of Δ, the better the elastic recovery of the jounce bumper.

The data in Tables 1 and 2 show that in all cases the annealing treatment according to the invention reduces the magnitude of Δ, meaning the elastic recovery of the jounce bumper is improved by the annealing treatment. Elastic recovery is further improved if the pre-loading is carried out also at elevated temperature, e.g. 70 or 120° C. Control C3 shows that annealing for only 15 minutes does not give a significant reduction in Δ.

TABLE 1
Outward jounce bumpers having the following
dimensions: number of bellows: 4; wall thickness profile:
Tc = 2.8 mm; Ts = 1.7 mm; other dimensions: Re = 18.5 mm;
Ri = 11.8 mm; P = 15 mm.

| | | | Height (mm) | | Relative |
|---|---|---|---|---|---|
| Jounce | | | 1 hour | 24 hours | loss of |
| bumper | Conditioning | | after pre- | after fatigue | height |
| reference | | Pre- | loading, | treatment, | after |
| number | Annealing | loading | h₀ | h₂₄ | fatigue Δ |
| C1 | NO | 23° C. | 58.5 | 51.7 | 11.6 |
| EX1 | 1 hour @ | 23° C. | 58.4 | 52.5 | 10.1 |
| | 70° C. | | | | |
| EX2 | 1 hour @ | 23° C. | 58.4 | 52.7 | 9.8 |
| | 120° C. | | | | |
| EX3 | 1 hour @ | 70° C. | 55.7 | 51 | 8.4 |
| | 70° C. | | | | |
| EX4 | 1 hour @ | 120° C. | 51.6 | 46.7 | 9.5 |
| | 120° C. | | | | |

TABLE 2
Inward jounce bumpers having the following
dimensions: number of bellows: 2.5; wall thickness profile:
Tc = 3.9 mm; Ts = 2.25 mm; other dimensions: Re = 32.7 mm;
Ri = 20.7 mm; P = 24 mm.

| | | | Height (mm) | | Relative |
|---|---|---|---|---|---|
| Jounce | | | 1 hour | 24 hours | loss of |
| bumper | Conditioning | | after pre- | after fatigue | height |
| reference | | Pre- | 1 loading, | treatment, | after |
| number | Annealing | loading | h₀ | h₂₄ | fatigue (Δ) |
| C2 | NO | 23° C. | 65.5 | 58.6 | 10.5 |
| C3 | 15 minutes | 23° C. | 65.4 | 58.6 | 10.4 |
| | @ 70° C. | | | | |
| EX5 | 1 hour @ | 23° C. | 65.4 | 59.1 | 9.6 |
| | 70° C. | | | | |
| EX6 | 2 hours @ | 23° C. | 65.4 | 59.2 | 9.5 |
| | 70° C. | | | | |
| EX7 | 1 hour @ | 70° C. | 62.1 | 57.8 | 6.9 |
| | 70° C. | | | | |

1. A process for enhancing the elastic recovery of a jounce bumper made from copolyester thermoplastic elastomer having polyester hard segments and polyoxyalkylene soft segments, the process comprising:
A) providing a jounce bumper made from copolyester thermoplastic elastomer;
B) annealing the jounce bumper at an annealing temperature that is at least at or about the T_{g} of the polyester making up the hard segments of the copolyester thermoplastic elastomer for a period of 20 to 60 minutes to form an annealed jounce bumper having an uncompressed thickness;
C) pre-loading the annealed jounce bumper, at a pre-loading temperature that is at least room temperature, by compressing it to reduce its height by 20 to 90% of its uncompressed height;
D) releasing the compression;
E) repeating steps C) and D) at least once; and
F) allowing the jounce bumper to cool to less than 30° C.

2. A process according to claim 1, wherein the pre-loading temperature is at least at or about the T_{g} of the polyester making up the hard segments of the copolyester thermoplastic elastomer.

3. A process according to claim 1, wherein the jounce bumper is made from a copolyester thermoplastic elastomer having
poly(butyleneterephthalate) hard segments, and the annealing temperature is between 70-120° C.

4. A process according to claim 1, wherein the jounce bumper is made from a copolyester thermoplastic elastomer having
poly(butyleneterephthalate) hard segments, and the pre-loading temperature is between 70-120° C.

5. A process according to claim 1, wherein the pre-loading step is carried out using at least 2 cycles of compression from 0 to at least 50% of relative deformation of the jounce bumper.

6. A process according to claim 1, wherein the pre-loading step is carried out by compression with 0-10 kN at about 50 mm/minute.

7. A process for enhancing the elastic recovery of a jounce bumper made from copolyester thermoplastic elastomer having polyester hard segments and polyoxyalkylene soft segments, the process comprising:
A) forming a jounce bumper from copolyester thermoplastic elastomer by extrusion and/or blow-moulding;
B) annealing the jounce bumper at an annealing temperature that is at least at or about the Tg of the polyester making up the hard segments of the copolyester thermoplastic elastomer for a period of 20 to 60 minutes to form an annealed jounce bumper having an uncompressed height;
C) compressing, at a pre-loading temperature that is at least room temperature the annealed jounce bumper to reduce its height by 20 to 90% of its uncompressed height;
D) releasing the compression;
E) repeating steps C) and D) at least once; and
F) allowing the jounce bumper to cool to less than 30° C.

8. A process according to claim 7, wherein the pre-loading temperature is at least at or about the T_{g} of the polyester making up the hard segments of the copolyester thermoplastic elastomer.

9. A process according to claim 7, wherein the jounce bumper is made from a copolyester thermoplastic elastomer having
poly(butyleneterephthalate) hard segments, and the annealing temperature is between 70-120° C.

10. A process according to claim 7, wherein the jounce bumper is made from a copolyester thermoplastic elastomer having
poly(butyleneterephthalate) hard segments, and the pre-loading temperature is between 70-120° C.

11. A process according to claim 7, wherein the pre-loading step is carried out using at least 2 cycles of compression from 0 to at least 50% of relative deformation of the jounce bumper.

12. A process according to claim 7, wherein the pre-loading step is carried out by compression with 0-10 kN at about 50 mm/minute.
